(19) United States
(12) Patent Application Publication
(10) Pub. No.: US 2012/0050124 A1
(43) Pub. Date: Mar. 1, 2012

(54) ANTENNA FOR SUPPRESSING HARMONIC SIGNALS

(75) Inventor: HSIN-LUNG TU, Tu-Cheng (TW)

(73) Assignee: HON HAI PRECISION INDUSTRY CO., LTD., Tu-Cheng (TW)

(21) Appl. No.: 12/894,123

(22) Filed: Sep. 29, 2010

(30) Foreign Application Priority Data
Aug. 26, 2010 (CN) 201010263682.7

(51) Int. Cl. H01Q 13/10

(52) U.S. Cl. 343/770

(57) ABSTRACT

An antenna is formed by a conductive metal layer disposed on a substrate, and includes a radiating portion and a feeding portion. The radiating portion defines a first rectangle slot, a second rectangle slot parallel to the first rectangle slot, a first stripe slot perpendicularly communicating with the first rectangle slot, a second stripe slot perpendicularly communicating with the second rectangle slot and in parallel to the first stripe slot, and a plurality of spiral slots communicating with the first and second rectangle slots, respectively. The feeding portion is formed by the conductive metal layer located between the first stripe slot and the second stripe slot to feeding electromagnetic signals.

### BACKGROUND

1. Technical Field

Embodiments of the present disclosure relate to antennas, and more particularly to an antenna for suppressing harmonic signals.

2. Description of Related Art

An antenna and a power amplifier (PA) are primary components of a transceiver. The antenna is used to radiate and receive electromagnetic signals. The power amplifier is used to amplify the electromagnetic signals before radiation. However, the power amplifier would generate harmonic signals when the power amplifier amplifies the electromagnetic signals because of a non-linear characteristic of the power amplifier. It is bad for radiating performance of the antenna if the harmonic signals are not effectively suppressed.

One way to ensure radiating performance of the antenna is to position a low pass filter (LPF) between the antenna and the power amplifier in the transceiver to suppress the harmonic signals generated by the power amplifier. However, the low pass filter would increase cost of the transceiver. Therefore, the antenna which can suppress the harmonic signals generated by the power amplifier is desired.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of one embodiment of an antenna of the present disclosure;

FIG. 2 is a graph showing a return loss of the antenna of FIG. 1;

FIG. 3 is a graph showing a gain of the antenna of FIG. 1;

FIG. 4 is a schematic diagram of another embodiment of an antenna of the present disclosure;

FIG. 5 illustrates dimensions of the antenna of FIG. 4;

FIG. 6 illustrates dimensions of a spiral slot of the antenna of FIG. 4;

FIG. 7 is a graph showing a return loss of the antenna of FIG. 4; and

FIG. 8 is a graph showing a gain of the antenna of FIG. 4.

### DETAILED DESCRIPTION

The details of the disclosure, both as to its structure and operation, can best be understood by referring to the accompanying drawings, in which like reference numbers and designations refer to like elements.

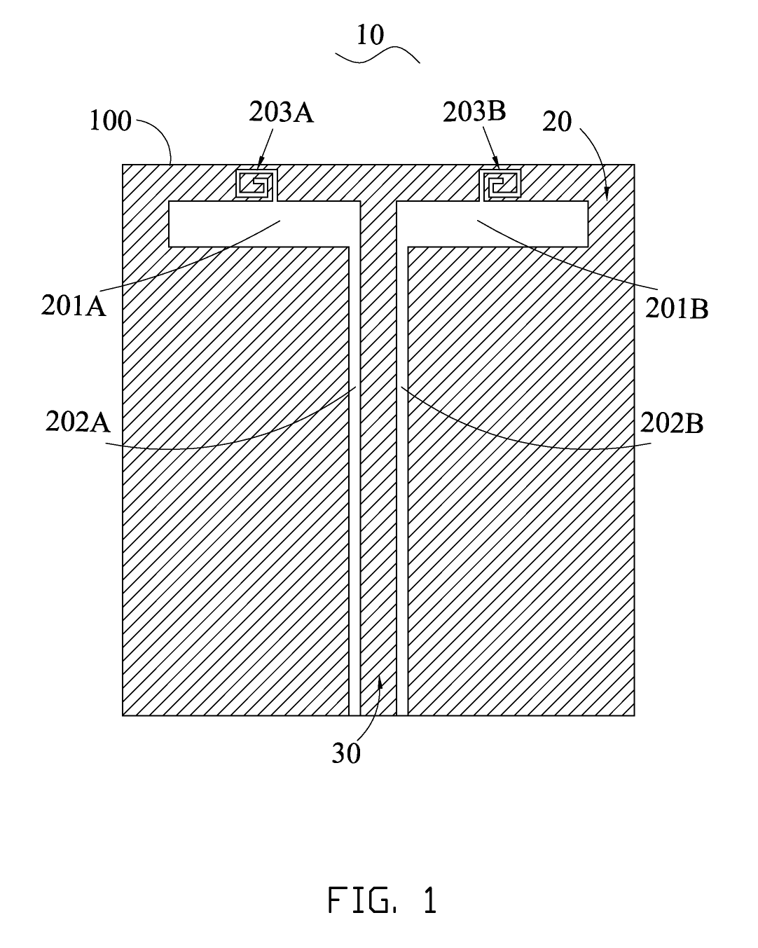

FIG. 1 is a schematic diagram of one embodiment of an antenna 10 of the present disclosure. The antenna 10 comprises a radiating portion 20 and a feeding portion 30, which are formed by a conductive metal layer disposed on a substrate 100.

The radiating portion 20 defines a plurality of slots to radiate electromagnetic signals by way of resonance. In one embodiment, the radiating portion 20 defines a first rectangle slot 201A, a second rectangle slot 201B parallel to the first rectangle slot 201A, a first stripe slot 202A perpendicularly communicating with the first rectangle slot 201A, a second stripe slot 202B perpendicularly communicating with the second rectangle slot 201B and in parallel to the first stripe slot 202A, a first spiral slot 203A, and a second spiral slot 203B. In one embodiment, the first rectangle slot 201A and the second rectangle slot 201B, the first stripe slot 202A and the second stripe slot 202B, and the first spiral slot 203A and the second spiral slot 203B are isolated by the feeding portion 30, respectively. In one embodiment, the first spiral slot 203A and the second spiral slot 203B are communicating with the first rectangle slot 201A and the second rectangle slot 201B, respectively.

In one embodiment, the first rectangle slot 201A and the first stripe slot 202A are substantially axial symmetric with the second rectangle slot 201B and the second stripe slot 202B, respectively. The first spiral slot 203A is substantially axial symmetric with the second spiral slot 203B. A symmetry axis of the first rectangle slot 201A and the second rectangle slot 201B, a symmetry axis of the first stripe slot 202A and the second stripe slot 202B, and a symmetry axis of the first spiral slot 203A and the second spiral slot 203B are an axis line of the feeding portion 30.

In one embodiment, the first rectangle slot 201A and the first stripe slot 202A collectively form an L-shape, and the second rectangle slot 201B and the second stripe slot 202B collectively form another L-shape.

The feeding portion 30 is formed by the conductive metal layer located between the first stripe slot 202A and the second stripe slot 202B, to feeding electromagnetic signals. In one embodiment, the feeding portion 30 feeds electromagnetic signals by way of coplanar waveguide (CPW).

In one embodiment, both the first spiral slot 203A and the second spiral slot 203B are composed by a plurality of L-shaped slots communicated one by one. In one embodiment, a spiral direction of the first spiral slot 203A and a spiral direction of the second spiral slot 203B are opposite to each other. For example, the first spiral slot 203A spirals in an anticlockwise direction, and the second spiral slot 203B spirals a clockwise direction.

In one embodiment, the radiating portion 20 radiates the electromagnetic signals feed by the feeding portion 30 by way of forming resonance among the plurality of slots. In one embodiment, the radiating portion 20 further connects to the ground.

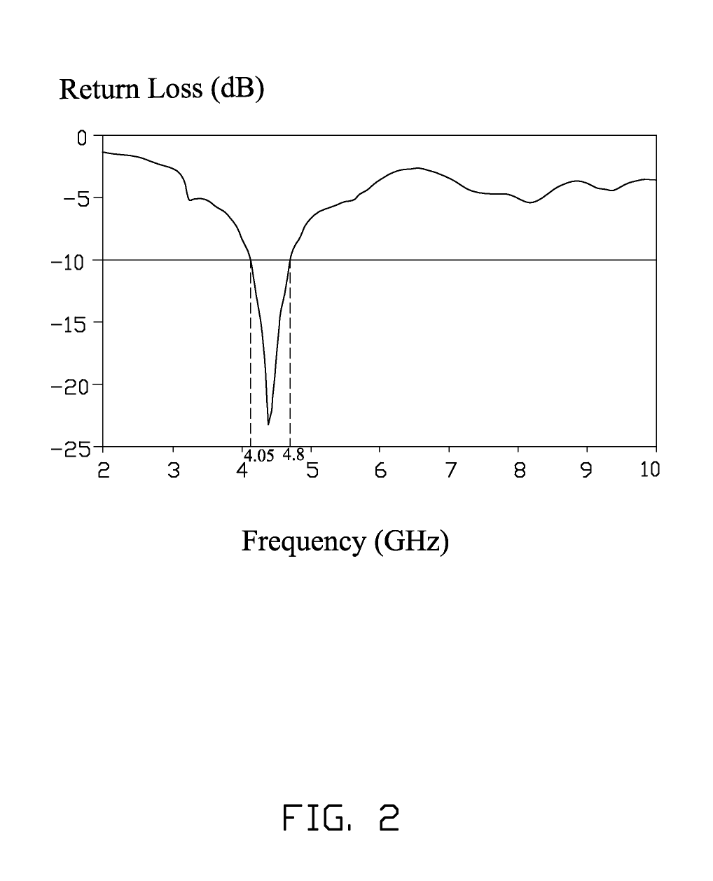

FIG. 2 is a graph showing a return loss of the antenna 10 of FIG. 1. As shown, a frequency band covered by the antenna 10 with a return loss which is less than −10 dB is from 4.05 GHz to 4.80 GHz, so the frequency band between 4.05 GHz˜4.80 GHz is called base-band and another frequency band between 8.1 GHz˜9.6 GHz is called frequency-double. As shown, a return loss between 8.1 GHz˜9.6 GHz is more than −10 dB, so the antenna 10 of FIG. 1 can suppress a second-harmonic corresponding to the frequency-double.

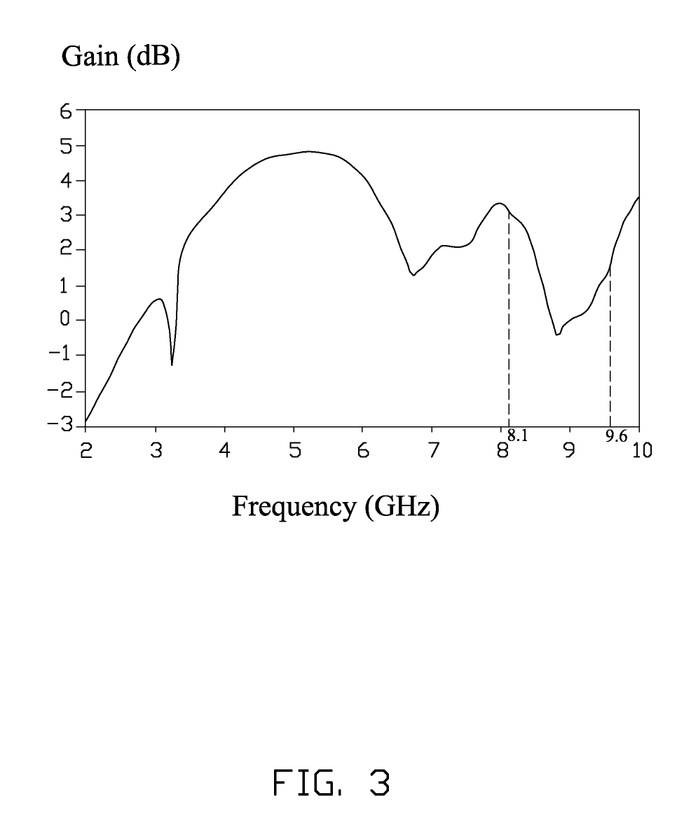

FIG. 3 is a graph showing a gain of the antenna 10 of FIG. 1. As shown, a gain between 8.1 GHz˜9.6 GHz is small, so the antenna 10 of FIG. 1 can suppress a second-harmonic corresponding to the frequency-double by way of defining the first rectangle slot 201A, the second rectangle slot 201B, the first stripe slot 202A, the second stripe slot 202B, the first spiral slot 203A, and the second spiral slot 203B together.

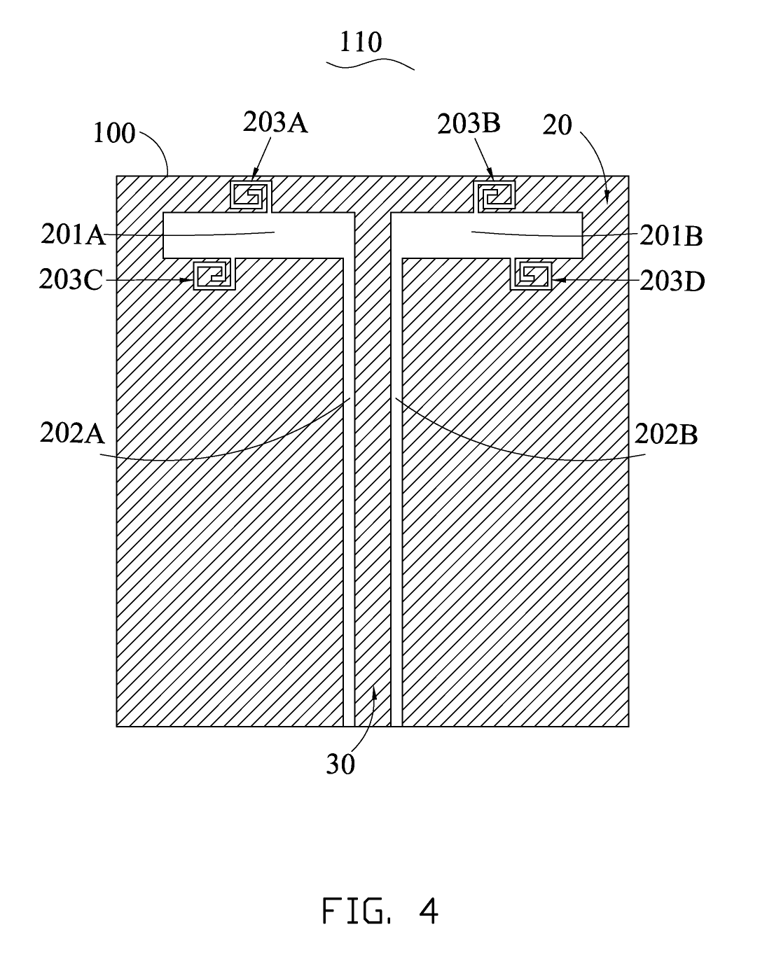

FIG. 4 is a schematic diagram of another embodiment of an antenna 110 of the present disclosure. As shown, the antenna 110 is formed by defining a third spiral slot 203C and a fourth spiral slot 203D on the basis of the antenna 10 of FIG. 1. In one embodiment, the third spiral slot 203C is substantially axial symmetry with the fourth spiral slot 203D. A symmetry axis of the third spiral slot 203C and the fourth spiral slot 203D, and the symmetry axis of the first rectangle slot 201A and the second rectangle slot 201B are the axis line of the feeding portion 30. In one embodiment, the third spiral slot 203C and the fourth spiral slot 203D are isolated by the feeding portion 30, and the third spiral slot 203C and the fourth spiral slot 203D are communicating with the first rectangle slot 201A and the second rectangle slot 201B, respectively.

In one embodiment, both the third spiral slot 203C and the fourth spiral slot 203D are also composed by a plurality of L-shaped slots communicated one by one. In one embodiment, a spiral direction of the third spiral slot 203C and a spiral direction of the fourth spiral slot 203D are opposite to each other. For example, the third spiral slot 203C is spiral in clockwise, and the fourth spiral slot 203D is spiral in anticlockwise.

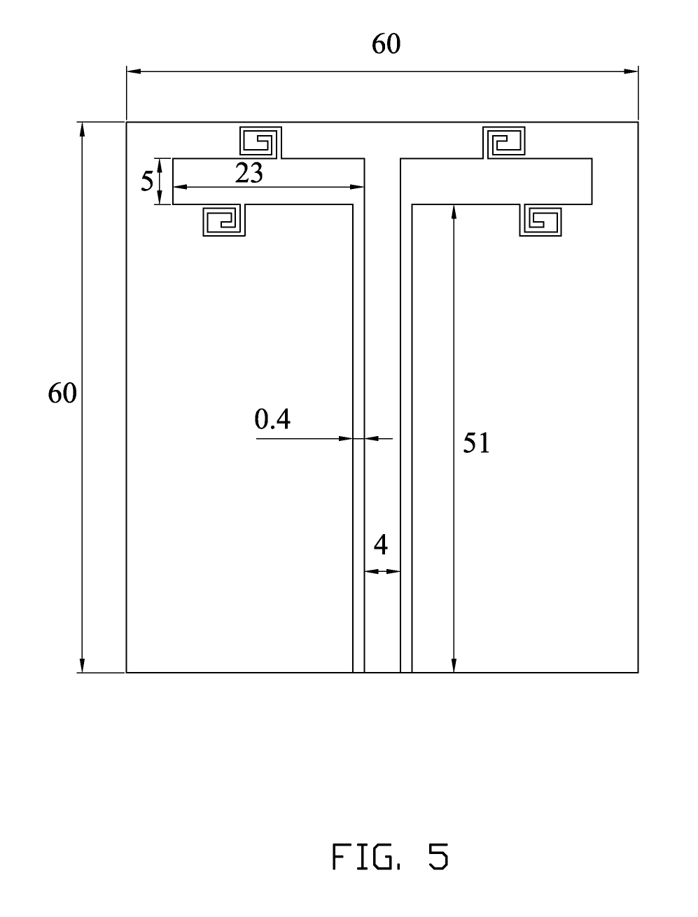

FIG. 5 illustrates dimensions of the antenna 110 of FIG. 4. In one embodiment, the substrate 100 is a circuit board with a type of FR4, and the length and the width of the substrate 100 are substantially equal to 60 mm and 60 mm, respectively. The thickness of the substrate 100 is substantially equal to 0.8 mm. The length and the width of the first rectangle slot 201A (or the second rectangle slot 201B) are substantially equal to 23 mm and 5 mm, respectively. The length and the width of the first stripe slot 202A (or the second stripe slot 202B) are substantially equal to 51 mm and 0.4 mm, respectively. The first stripe slot 202A and the second stripe slot 202B are apart away about 4 mm.

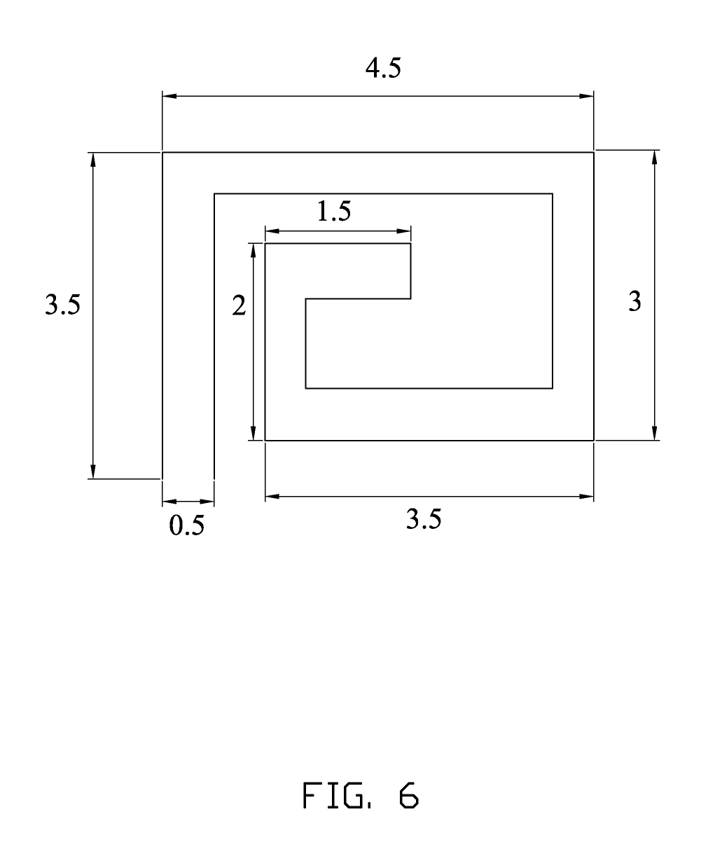

FIG. 6 illustrates dimensions of a spiral slot of the antenna 110 of FIG. 4. In one embodiment, the width of the first spiral slot 203A, the second spiral slot 203B, the third spiral slot 203C, or the fourth spiral slot 203D are all substantially equal to 0.5 mm. The lengths of the plurality of L-shaped slots are substantially equal to 3.5 mm, 4.5 mm, 3 mm, 3.5 mm, 2 mm, and 1.5 mm in sequence.

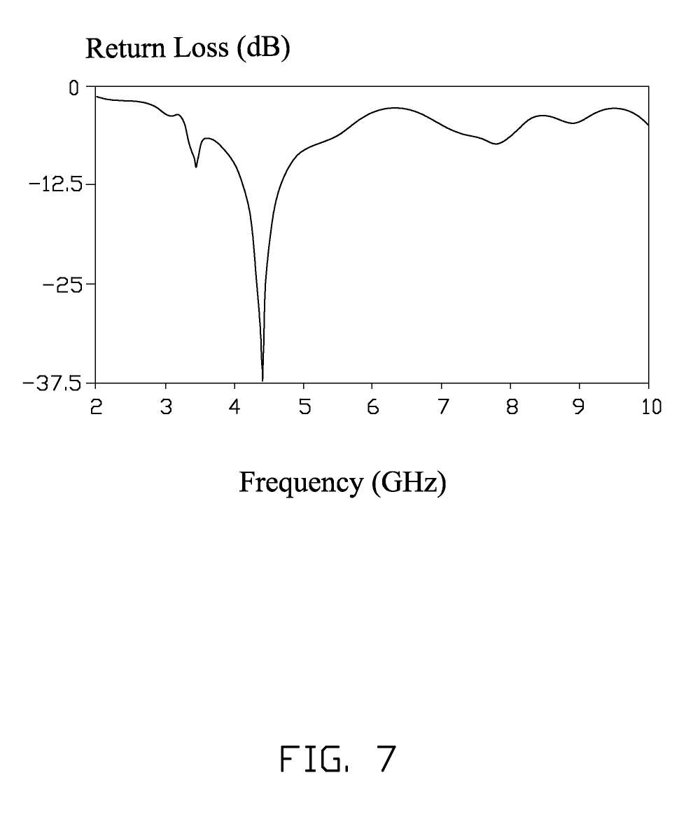

FIG. 7 is a graph showing a return loss of the antenna 110 of FIG. 4. As shown, a return loss between 8.1 GHz˜9.6 GHz is more than −10 dB, so the antenna 110 of FIG. 4 can suppress a second-harmonic corresponding to the frequency-double.

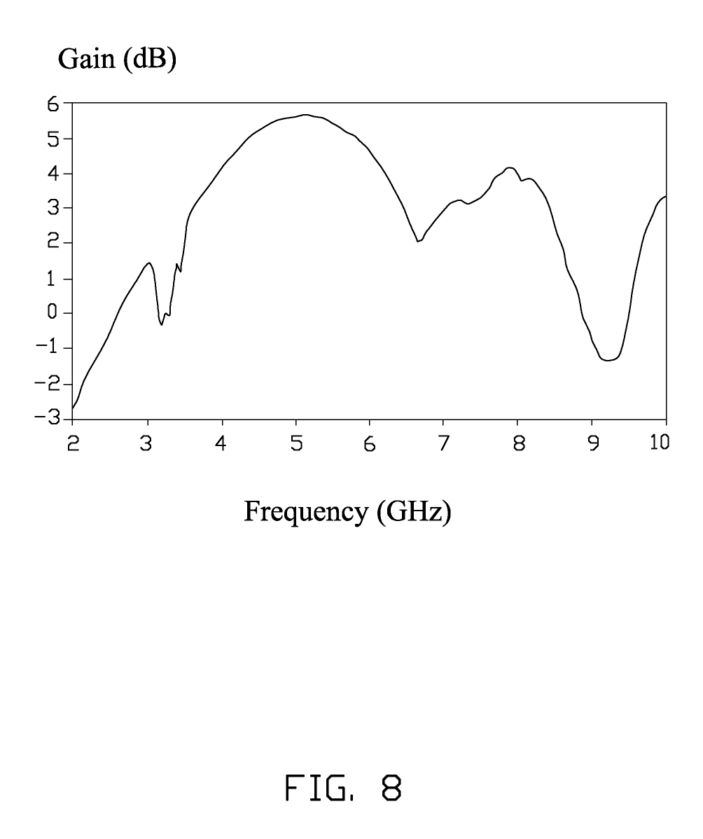

FIG. 8 is a graph showing a gain of the antenna 110 of FIG. 4. As shown, a gain between 8.1 GHz˜9.6 GHz of the antenna 110 is smaller than that of the antenna 10 of FIG. 3, so the antenna 110 of FIG. 4 can suppress the second-harmonic corresponding to the frequency-double better than the antenna 10 of FIG. 1.

It is further noted that the number of the spiral slots on the antenna 10 (or on the antenna 110) would not be limited to two (or four). In other embodiments, more spiral slots can be defined by the antenna 10 of FIG. 1 and the second-harmonic corresponding to the frequency-double can be better suppressed.

In one embodiment, both the antenna 10 and the antenna 110 can suppress the second-harmonic corresponding to the frequency-double by way of defining the first rectangle slot 201A, the second rectangle slot 201B, the first stripe slot 202A, the second stripe slot 202B, and a plurality of spiral slots together.

While various embodiments and methods of the present disclosure have been described, it should be understood that they have been presented by example only and not by limitation. Thus the breadth and scope of the present disclosure should not be limited by the above-described embodiments, but should be defined only in accordance with the following claims and their equivalents.

What is claimed is:

1. An antenna formed by a conductive metal layer disposed on a substrate, the antenna comprising:
a radiating portion defining a first rectangle slot, a second rectangle slot parallel to the first rectangle slot, a first stripe slot perpendicularly communicating with the first rectangle slot, a second stripe slot perpendicularly communicating with the second rectangle slot and in parallel to the first stripe slot, and a plurality of spiral slots communicating with the first and second rectangle slots, respectively; and
a feeding portion formed by the conductive metal layer located between the first stripe slot and the second stripe slot, to feed electromagnetic signals;
wherein the first rectangle slot and the second rectangle slot, the first stripe slot and the second stripe slot are isolated by the feeding portion, respectively.

2. The antenna as claimed in claim 1, wherein the first rectangle slot and the first stripe slot are substantially axial symmetric with the second rectangle slot and the second stripe slot, respectively.

3. The antenna as claimed in claim 2, wherein a symmetry axis of the first rectangle slot and the second rectangle slot, and a symmetry axis of the first stripe slot and the second stripe slot are an axis line of the feeding portion.

4. The antenna as claimed in claim 1, the plurality of spiral slots comprises a first spiral slot and a second spiral slot, wherein the first spiral slot and the second spiral slot are isolated by the feeding portion, and the first spiral slot and the second spiral slot are communicating with the first and second rectangle slots, respectively.

5. The antenna as claimed in claim 4, the plurality of spiral slots further comprises a third spiral slot and a fourth spiral slot, wherein the third spiral slot and the fourth spiral slot are isolated by the feeding portion, and the third spiral slot and the fourth spiral slot are communicating with the first and second rectangle slots, respectively.

6. The antenna as claimed in claim 5, wherein the third spiral slot is substantially axial symmetric with the fourth spiral slot.

7. The antenna as claimed in claim 6, wherein a symmetry axis of the third spiral slot and the fourth spiral slot, and the symmetry axis of the first rectangle slot and the second rectangle slot are an axis line of the feeding portion.

8. The antenna as claimed in claim 5, wherein a spiral direction of the first spiral slot and a spiral direction of the second spiral slot are opposite to each other, and a spiral direction of the third spiral slot and a spiral direction of the fourth spiral slot are opposite to each other.

9. The antenna as claimed in claim 1, wherein each spiral slot is composed by a plurality of L-shaped slots communicated one by one.
